(19) United States
(12) Patent Application Publication
(10) Pub. No.: US 2010/0292102 A1
(43) Pub. Date: Nov. 18, 2010

(54) System and Method For Preventing Synthesis of Dangerous Biological Sequences

(76) Inventor: Ali Nouri, Washington, DC (US)

Correspondence Address: MCCARTER & ENGLISH, LLP NEWARK, FOUR GATEWAY CENTER, 100 MULBERRY STREET, NEWARK, NJ, 07102, US

(21) Appl. No.: 12/780,456

(22) Filed: May 14, 2010

Related U.S. Application Data
(60) Provisional application No. 61/178,228, filed on May 14, 2009.

(51) Int. Cl. C40B 40/06; G06F 12/00; G06F 17/30

(52) U.S. Cl. 506/16; 711/154; 707/758; 707/E17.009; 711/E12.001

(57) ABSTRACT

A system and method for prohibiting synthesis of dangerous biological sequences are provided. The system includes a synthesizer for synthesizing biological sequences, a computer system in communication with the synthesizer, and a database including at least one prohibited biological sequence for which synthesis is prohibited. The system receives a requested biological sequence for which synthesis is desired, and compares the requested biological sequence to the database. The system prohibits synthesis of the requested biological sequence by the synthesizer if the requested biological sequence matches at least one prohibited biological sequence in the database, and allows synthesis of the requested biological sequence by the synthesizer if no match is found in the database. The computer system could form part of the synthesizer, and the requested biological sequence could be input by a user using a control panel of the synthesizer. A centralized security server is also provided for central monitoring and control of synthesis by one or more remote synthesizers, and a security chip is provided for securing individual synthesizers.

### RELATED APPLICATIONS

This application claims the benefit of U.S. Provisional Application Ser. No. 61/178,228 filed May 14, 2009, the disclosure of which is expressly incorporated herein by reference in its entirety.

### FIELD OF THE INVENTION

The present invention relates to a system and method for secure synthesis of biological sequences, such as DNA, RNA, gene sequences, and protein sequences.

### RELATED ART

In the biotechnology field, biological sequences (e.g., DNA sequences, RNA sequences, gene sequences, protein sequences, etc.) are often synthesized using automated synthesis equipment. Such equipment is often computer-controlled, and a requested sequence can be specified by a user by simply typing the sequence into the synthesizer. Synthesizers create “templates” of biological material in accordance with the requested synthesis, which can subsequently be mass-produced (or, “amplified”) by growing the template in bacteria.

In the research community, biological sequences which correspond to dangerous biological agents and/or toxins are synthesized for study and analysis. Current security measures in place to control the synthesis of such dangerous materials lie in the regulation by governmental agencies of facilities authorized to carry out such synthesis. Further, such security measures are currently undertaken only on a voluntary basis. As such, there is a risk that a synthesizer could be operated by an unauthorized person to synthesize dangerous substances, thus presenting a potential danger to the general public.

### SUMMARY OF THE INVENTION

The present invention relates to a system and method for preventing synthesis of dangerous biological sequences. The system includes a synthesizer for synthesizing biological sequences, a computer system in communication with the synthesizer, and a database including at least one prohibited biological sequence for which synthesis is prohibited. The system includes means for receiving a requested biological sequence for which synthesis is desired, and means for comparing the requested biological sequence to the database and prohibiting synthesis of the requested biological sequence by the synthesizer if the requested biological sequence matches at least one prohibited biological sequence in the database, and allowing synthesis of the requested biological sequence by the synthesizer if no match is found in the database. The computer system could form part of the synthesizer, and the requested biological sequence could be input by a user using a control panel of the synthesizer.

In another aspect, the system for preventing synthesis of dangerous biological sequences includes a central security server in communication with a remote synthesizer and a computer system remote from the central security server. The system includes means in the central security server for receiving a requested biological sequence transmitted to the central security server by a user of the computer system, and a database in the central security server including at least one prohibited biological sequence for which synthesis is prohibited. The system further includes means for comparing the requested biological sequence to the database and prohibiting synthesis of the requested biological sequence by the remote synthesizer if the requested biological sequence matches at least one prohibited biological sequence in the database, and allowing synthesis of the requested biological sequence by the remote synthesizer if no match is found in the database. The system also includes means for transmitting the requested biological sequence to the remote synthesizer for subsequent synthesis of the requested biological sequence by the synthesizer if no match is found in the database. The system could also include means for verifying the identity of the user, and means for encrypting the requested biological sequence prior to transmission of the requested biological sequence to the central security server. The central security server could communicate with a central database of prohibited biological sequences external to the central security server, as well as with a governmental agency if the requested biological sequence matches one or more prohibited biological sequences.

In still another aspect, a chip for preventing synthesis of dangerous biological sequences by a synthesizer is provided. The chip includes a non-volatile memory storing at least one biological sequence for which synthesis is prohibited, and means for communicating with a controller of the synthesizer. The controller obtains the at least one biological sequence from the non-volatile memory and compares the at least one biological sequence with a requested biological sequence to determine whether to synthesize the requested biological sequence. The synthesizer could cease functioning when the chip is removed from the synthesizer.

In yet another aspect, the chip for preventing synthesis of dangerous biological sequences includes an on-chip database storing at least one biological sequence for which synthesis is prohibited, a processor in communication with the on-chip database, means for receiving a requested biological sequence for which synthesis is desired, and means for comparing the requested biological sequence to the on-chip database. The processor instructs the synthesizer to prohibit synthesis of the requested biological sequence if the requested biological sequence matches at least one biological sequence in the on-chip database for which synthesis is prohibited. The synthesizer could cease functioning when the chip is removed from the synthesizer.

In a further aspect, a method for preventing synthesis of dangerous biological sequences is provided. The method includes the steps of receiving at a computer system a requested biological sequence for which synthesis is desired, comparing the requested biological sequence to a database containing at least one biological sequence for which synthesis is prohibited, determining whether the requested biological sequence matches at least one biological sequence in the database, if the requested biological sequence does not match at least one biological sequence in the database, electronically instructing a synthesizer in communication with the computer system to synthesize the requested biological sequence, and if the requested biological sequence matches at least one biological sequence in the database, electronically locking a synthesizer in communication with the computer system to prohibit synthesis of the requested biological sequence.

In still a further aspect, a computer-readable storage medium is provided having computer-readable instructions stored thereon which, when executed by a computer system, cause the computer system to prevent synthesis of dangerous biological sequences by a synthesizer in communication with the computer system. The instructions include the steps of: receiving at a computer system a requested biological sequence for which synthesis is desired, comparing the requested biological sequence to a database containing at least one biological sequence for which synthesis is prohibited, determining whether the requested biological sequence matches at least one biological sequence in the database, if the requested biological sequence does not match at least one biological sequence in the database, electronically instructing a synthesizer in communication with the computer system to synthesize the requested biological sequence; and if the requested biological sequence matches at least one biological sequence in the database, electronically locking a synthesizer in communication with the computer system to prohibit synthesis of the requested biological sequence.

### BRIEF DESCRIPTION OF THE DRAWINGS

The foregoing features of the invention will be apparent from the following Detailed Description of the Invention, taken in connection with the accompanying drawings, in which:

FIG. 1 is a diagram showing one aspect of the system for preventing synthesis of dangerous biological sequences;

FIG. 2 is block diagram showing hardware and software/firmware components of the system of FIG. 1 in greater detail;

FIG. 3 is a flowchart showing processing steps carried out by the system for preventing synthesis of dangerous biological sequences;

FIGS. 4-6 are diagrams showing another aspect of the system for preventing synthesis of dangerous biological sequences, wherein centralized security is provided;

FIG. 7 is a diagram showing another aspect of the system for preventing synthesis of dangerous biological sequences, wherein a security chip is provided; and

FIG. 8 is a block diagram showing hardware and software/firmware components of the security chip of FIG. 7 in greater detail.

### DETAILED DESCRIPTION OF THE INVENTION

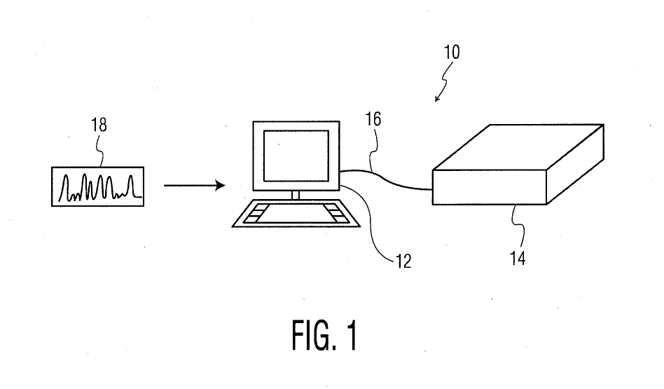

The present invention relates to a system and method for preventing synthesis of dangerous biological sequences, as discussed in detail below in connection with FIGS. 1-8. The term “biological sequence,” as used herein, includes, but is not limited to, biopolymers, DNA sequences, RNA sequences, gene sequences, protein sequences, amino acid sequences, and/or nucleotide sequences of any desired length, any portions thereof, and any analogs or derivatives thereof.

FIG. 1 is a diagram showing one aspect of the system for preventing synthesis of dangerous biological sequences, indicated generally at 10. The system 10 includes a computer system 12 which is in communication with a synthesizer 14 via a communications cable 16 (e.g., a USB connection, serial connection, Ethernet connection, etc.). The computer system 12 could also wirelessly communicate with the synthesizer 14 (e.g., by Bluetooth (R) wireless connection). The synthesizer 14 could be any suitable, commercially-available synthesizer capable of synthesizing sequences of biological compounds (e.g. DNA sequences, gene sequences, protein sequences, etc.), such as the OLIGO 1000 DNA synthesizer manufactured by Beckman Coulter, Inc., or any other suitable type of synthesizer (e.g., synthesizers suitable for synthesizing complex and/or long DNA molecules). The computer system 12 executes a security software engine/module (discussed in greater detail below) which prohibits sequencing of dangerous biological compounds by the synthesizer 14, such as DNA sequences, RNA sequences, gene sequences, protein sequences, nucleotide sequences, amino acid sequences, etc. It is noted that the computer 12 need not be a standalone computer system, but rather, could be a computer system embedded within the synthesizer 14 (e.g., the computer 12 could be a digital controller forming part of the synthesizer 14). In such circumstances, a user of the synthesizer 14 could input a requested sequence for which synthesis is desired using a control panel of the synthesizer 14.

The computer 12 receives a requested biological sequence 18 (which could be input into the computer 12 by a user of the computer 12, or transmitted thereto), and compares the requested biological sequence to a database of one or more prohibited biological sequences stored in the computer 12. If a match is found, the computer 12 prevents the synthesizer 14 from synthesizing the requested sequence. By the terms “match” and “matching” used herein, it is meant both an identical match between the requested biological sequence and one or more prohibited sequences, and a nearly identical match between the requested biological sequence and one or more prohibited sequences. For example, the computer system 12 could be programmed to identify probabilities and/or degrees of similarity between the requested biological sequence and one or more prohibited biological sequences, and to allow or prohibit synthesis based upon pre-programmed rules corresponding to one or more probabilities and/or degrees of similarity. As such, the system 10 could include built-in margins of safety. Also, authorized users of the system 12 could have access to software updates/patches, as such updates/patches become available, to permit synthesis by such users of specific agents.

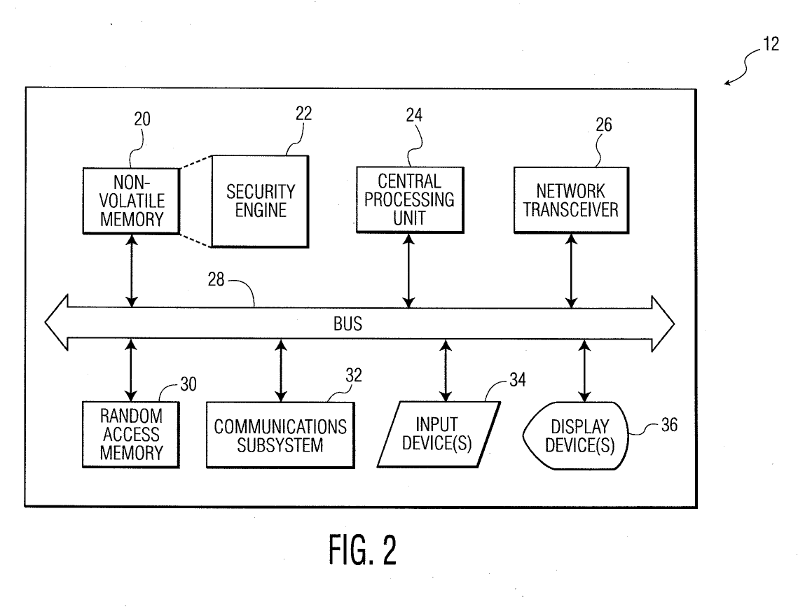

FIG. 2 is block diagram showing hardware and software/firmware components of the computer system 12 of FIG. 1 in greater detail. The computer system 12 could be any commercially-available computer system, such as a personal computer, portable computer (e.g., personal digital assistant (PDA), laptop computer, handheld computer, etc.), or an embedded computer system (e.g., forming part of the synthesizer 14 or separate therefrom). The computer 12 includes a non-volatile memory 20 which stores a security software/firmware engine 22, a central processing unit (CPU) 24, an optional network transceiver 26, a bus 28, a random access memory (RAM) 30, a communications subsystem 32, one or more input device(s) 34, and one or more display device(s) 36. The non-volatile memory 20 could include any suitable, non-volatile, computer-readable storage medium such as read-only memory (ROM), eraseable, programmable ROM (EPROM), electrically-eraseable, programmable ROM (EEPROM), flash memory, field-programmable gate array (FPGA), or any other suitable type of storage medium. As discussed in greater detail below, the security engine 22 provides security by determining whether one or more biological sequences requested for synthesis represents a dangerous and/or prohibited sequence, and if so, by preventing the synthesizer 14 from synthesizing the requested sequence. The CPU 24 could include any suitable type multiple or single core processor architecture, such as an Intel, SPARC, or Motorola microprocessor, or any other suitable microprocessor. The optional network transceiver 26 permits the computer 12 to communicate with a network, such as the Internet, a local area network (LAN), a wide area network (WAN), etc. The RAM 30 could include any suitable type of RAM typically utilized in commercially-available computer systems, such as Dynamic RAM (DRAM). The communications subsystem 32 allows the computer 12 to communicate with one or more devices connected thereto using any desired hardware and/or communications protocol, such as serial RS-232, RS-488, infrared, universal serial bus (USB), wireless Bluetooth (R), etc. The input device(s) 34 could include one or more user input devices such as a keyboard, mouse, touch screen, track ball, etc. The output device(s) could include a display screen (e.g., liquid crystal display, cathode ray tube, etc.), touch screen, etc.

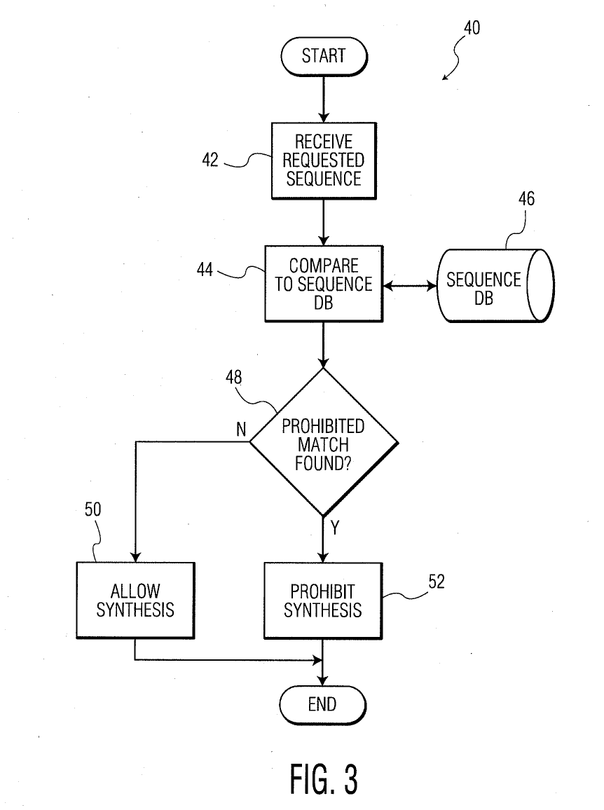

FIG. 3 is a flowchart showing processing steps 40 carried out by the security engine 22 of FIG. 2, for secure synthesis of biological sequences. The processing steps 40 could be coded in any suitable high or low level computing language, such as Java, C, C++, etc. Beginning in step 42, a requested biological sequence for which synthesis is desired is received from a party requesting synthesis. For example, the sequence could be entered using an input device associated with the computer system 12. The requested biological sequence could include a string of characters listing bases (e.g., cytosine, guanine, adenine, and thymine, identified by the letters C, G, A, and T). In step 44, the requested sequence is compared to a database 46 of biological sequences which have been identified as hazardous and/or prohibited from being synthesized. The database 46 could include sequences identified as agents of concern and/or regulated by the Centers for Disease Control and Prevention, the U.S. Department of Agriculture, or other agencies. Step 44 can be carried out using commercially-available biological sequence screening software, such as the “BlackWatch” sequence screening software application, and/or online sequence comparison tools provided by the National Center for

Biotechnology Information. In step 48, a determination is made as to whether a match is found with one or more prohibited sequenced in the database 46. If no match is found, step 50 occurs, wherein the present invention instructs the synthesizer to synthesize the requested sequence. Otherwise, step 52 occurs, wherein the present invention prevents the synthesizer from synthesizing the requested sequence.

It is noted that the database 46 could be updated to reflect regulatory changes affecting lists of regulated agents. Also, the engine 22 could be periodically updated (e.g., by way of periodic software/firmware patches) to provide additional screening functionality and/or to accommodate the aforementioned changes by regulatory agencies, and/or to permit authorized users to synthesize specific agents. Still further, the engine 22 could be pre-programmed to automatically permit synthesis of selected sequences, and to send an alert to a governmental agency in the event that a requested sequence matches a prohibited sequence.

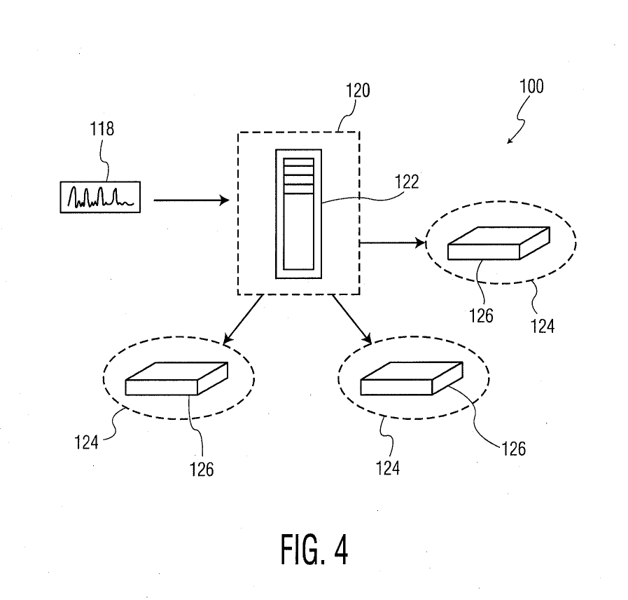

FIGS. 4-6 are diagrams showing another aspect of the system of the present invention, wherein a centralized security service (or, “clearinghouse”) is provided. As shown in FIG. 4, the system 100 includes a centralized, Internet-accessible security service 120 comprising a centralized security server 122. The server 122 includes a database of prohibited biological sequences, or is in communication with such a database external to the server 122. A requested sequence 118 is transmitted to the server 122 (e.g., via the Internet), whereupon the server 122 determines whether the sequence 118 corresponds to a prohibited sequence (i.e., by querying the database to determine whether a prohibited sequence matching the requested sequence 118 exists in the database). If the requested sequence 118 does not correspond to a prohibited sequence, the server 122 transmits the requested sequence to one or more remote synthesis sites 124, for synthesis of the sequence by one or more remote synthesizers 126.

It is noted that the server 122 could receive the sequence 118 from one or more operators of the synthesizers 126. For example, an operator of a synthesizer 126 could key in a desired sequence (e.g., using a control panel of the synthesizer 126), whereupon the synthesizer 126 could communicate the requested sequence to the server 122, via the Internet. If the server 122 does not identify the requested sequence 118 as a prohibited sequence, it could send a signal back to the synthesizer 126 authorizing it to synthesize the requested sequence. Also, the synthesizers 126 could be programmed not to operate if connection with the server 122 is lost or disabled, and, optionally, to communicate such an event to a law-enforcement agency. Still further, the server 122 could be programmed to identify and/or authenticate each user accessing the system. For example, Internet Protocol (IP) address of a computer system from which the requested sequence 118 has been issued could be tracked, to selectively allow or prohibit operation of one or more of the synthesizers 126 based upon the identified IP address of the requester. Such a feature not only provides added security, but it also guards against unnecessary denial of service for authorized requesters. Of course, other modes of authentication (e.g., biometrics, etc.) could be utilized without departing from the spirit or scope of the present invention.

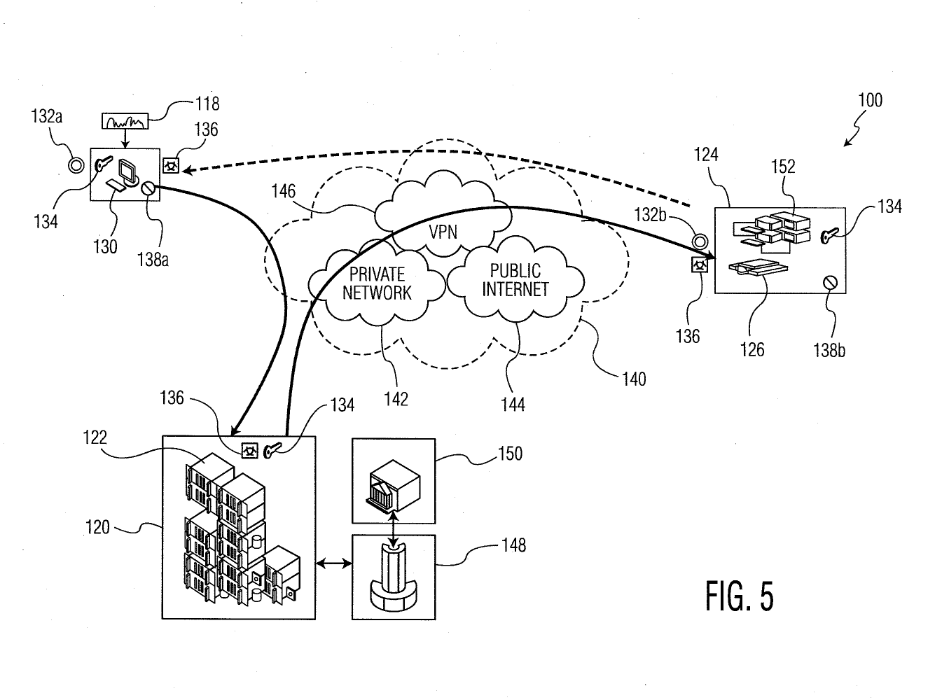

FIG. 5 shows the system 100 in greater detail. The requested sequence 118 could be specified by a user using a local computer system 130, which could be remote from a synthesis site 124. The requested sequence 118 corresponds to a biological agent 136 that the user desires to have synthesized. In order to request the sequence 118, the user must be verified using a verification process 132a (e.g., by logging into the server 122, or by using some other form of identification, such as biometric identification (e.g., fingerprint scan, retinal scan, etc.)). Once verified, the requested sequence 118 is processed by encryption process 138a, and is encrypted using a key 134 (e.g., public-key encryption, etc.). Then, the encrypted sequence is transmitted to the server 122 of the centralized security service 120 via a network 140, which could include one or more of the public interne 144, a private network 142, and/or a virtual private network (VPN) 146. The server 122 receives the encrypted sequence and decrypts it using the key 134. Then, it compares the requested sequence to one or more databases of prohibited sequences, which could be stored on the server 122 or remote therefrom. If the server 122 determines that the requested sequence matches a prohibited sequence, it sends a message back to the local computer system 130 for subsequent display to the user, indicating that the requested sequence 118 is not permitted to be synthesized. Otherwise, if the server 122 determines that the requested sequence does not match a prohibited sequence, it sends a message to the synthesizer 126 via the network 140 authorizing the synthesizer 126 to synthesize the requested sequence 118.

The message authorizing the synthesizer 126 to synthesize the requested sequence 118 could be received by a computer system 152, which could be separate from, or form a part of, the synthesizer 126. The message transmitted to the synthesizer 126 from the server 122 could include the requested sequence 118 embedded within the message, and the computer system 152 could decrypt the message using local process 138b and the key 134 to obtain the sequence 118. Also, the computer system 152 could execute verification process 132b to ensure that a person physically operating the synthesizer 126 is authorized to do so. When the requested sequence 118 has been obtained by the computer system 152, it instructs the synthesizer 126 to synthesize the sequence 118 to produce the biological agent 136. The biological agent 136, once synthesized, is then physically delivered to the party requesting synthesis (e.g., an operator of the local computer system 130).

It is noted that the centralized security service 120 could communicate with one or more publicly-available biological agent databases/servers 148. Also, the service 120 could communicate with one or more government agencies 150, such as a federal, state, or municipal law enforcement agency, investigative agencies, etc. For example, if the service 120 determines that synthesis of a prohibited biological agent has been requested, or that synthesis has been requested by a person/entity of interest to a government agency, the service 120 could communicate the identity of the requester, as well as the agent for which synthesis has been requested, to the agency 150 for follow-up and/or investigation.

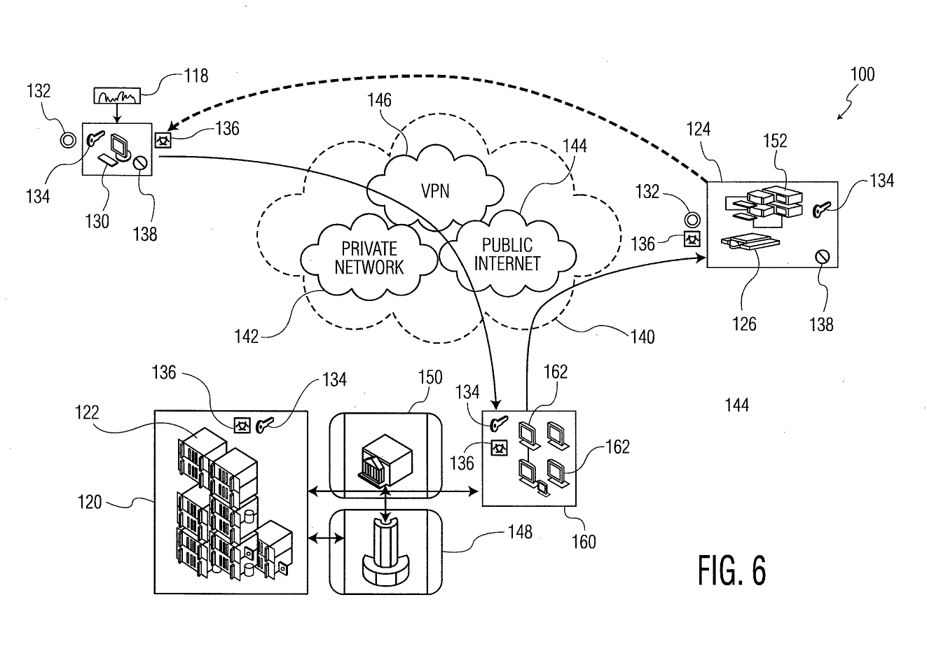

As shown in FIG. 6, the service 120 could also communicate with an operations control center 160 which handles all incoming requests for synthesis of sequences 118 received via the network 140. Also, the center 160 could allow for centralized, remote control of the service 120, and/or multiple services 120. Advantageously, the center 160 allows for human supervison of incoming requests for synthesis via one or more supervisory computer systems (terminals) 162, thereby augmenting the security features provided by the service 120. The center 160 could also allow for control/administration of the authentication keys 134, as well as the definitions of the sequences corresponding to one or more of the biological agents 136 and stored in the database(s) of the server 122. Also, multiple security features could be implemented for added security, e.g., a combination of security features such as user authentication, sequence comparison, biometrics, and/or other security features.

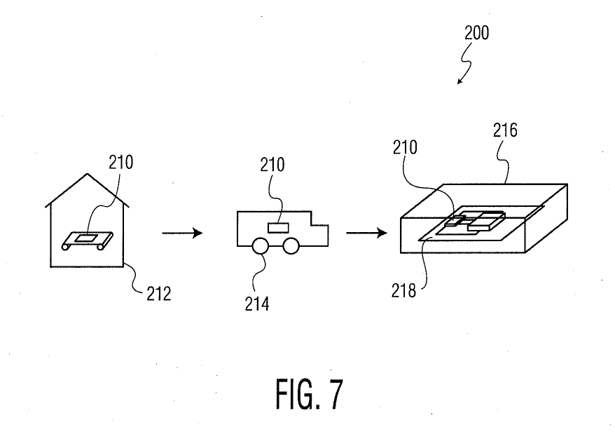

FIG. 7 is a diagram showing another aspect of the system, indicated generally at 200. The system 200 includes a hardware microchip 210 which includes an on-chip database of one or more sequences corresponding to prohibited biological agents. The chip 210 could incorporate the software/firmware security features discussed hereinabove in connection with FIG. 3. The on-chip database could be populated by an entity 212 having control of the chip 210, such as the manufacturer of the chip 210, a government agency, etc. The chip 210 could be physically transported to an operator of a synthesis device 216 by a courier 214 (e.g., by road, air, rail, water, etc.). The chip 210, once received by the operator of the synthesis device 216, is installed in the synthesis device 216 (e.g., by plugging the chip 210 into a socket on a printed circuit board forming the controller of the synthesis device 216). The synthesis device 216 could be programmed to be unable to function unless and until the chip 210 is installed, and to synthesize only those requested sequences which do not match one or more prohibited entries in the on-chip database.

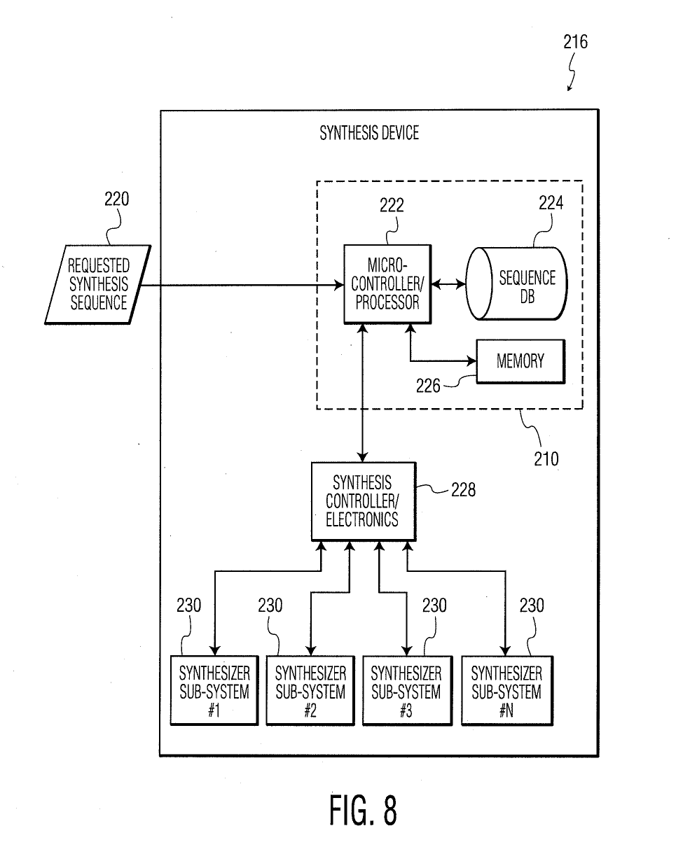

FIG. 8 is block diagram showing the chip 210 of FIG. 7 in greater detail. The chip 210 could include a microprocessor/microcontroller core 222, the aforementioned on-chip database 224, and a memory 226 (e.g., on-chip, non-volatile memory) which stores an on-chip security software engine for comparing a requested sequence 220 to the database 224 to determine whether to allow or prohibit synthesis of the sequence 220 by the controller 216. The on-chip database 224 could be stored in a separate, on-chip, non-volatile memory, or within the memory 226. The security software engine could be the engine 22 discussed above in connection with FIGS. 2-3. The microprocessor/microcontroller core 222 communicates with the synthesizer's control electronics 228 for controlling operation of the synthesizer 216. The control electronics 228, in turn, control one or more synthesizer subsystems 230 which operate to synthesize a requested sequence. The on-chip sequence database 224 and/or the memory 226 could be encrypted so as to prevent unauthorized access to the database and the security engine.

Of course, the chip 210 need not include the microcontroller/microprocessor core 222 and the memory 226 containing the security engine. Rather, the core 222 and the memory 226 could be installed on a circuit board of the synthesizer 216, and the chip 210 could include solely a non-volatile memory circuit which stores one or more prohibited sequences, and associated circuitry for allowing the non-volatile memory circuit to communicate with a controller of the synthesizer 216 so that the controller can access the one or more prohibited sequences to determine whether to synthesize a requested biological sequence. Removal of the chip 210 from the synthesizer 216 could optionally cause the synthesizer 216 to cease functioning, so as to provide additional security. The chip 210 could be periodically updated and/or replaced, so that the on-chip database is up-to-date.

Additional monitoring/security features could be implemented in various ways. For example, each synthesizer could be registered with the central security server, and the central security server could track information about each synthesizer including, but not limited to, the model number of the synthesizer, location, registered operator, etc. Moreover, the databases of the system could be automatically updated so that they contain up-to-date information about dangerous biological sequences, and the system could be programmed to automatically disable a synthesizer if an update to one or more databases has not been received within a pre-defined time period.

It is noted that the present invention could perform intelligent screening of requested biological sequences, in order to provided added security. For example, the system could identify each user requesting a sequence, and can determine whether the user is permitted to engage in synthesis activities generally, and/or whether a specific user is permitted to synthesize a specific sequence. Also, the system could track specific sequences requested for synthesis by a user over time, and could processes such sequences to determine whether the sequences, if combined into a larger sequence, represent a biological hazard. Such a capability could guard against the illicit synthesis of a biological hazard by breaking the sequence down into smaller parts, separately synthesizing the parts over time, and assembling the separately synthesized parts into a biological hazard. Both the remote central security server of the present invention (e.g., the system 100 of FIGS. 4-6), as well as the stand-alone versions of the invention (e.g., the system 10 of FIG. 1, as well as the system 200 of FIGS. 7-8), could implement such intelligent security features.

Having thus described the invention in detail, it is to be understood that the foregoing description is not intended to limit the spirit or scope thereof. What is desired to be protected is set forth in the following claims.

What is claimed is:

1. A system for prohibiting synthesis of dangerous biological sequences, comprising:
a synthesizer for synthesizing biological sequences;
a computer system in communication with the synthesizer;
a database including at least one prohibited biological sequence for which synthesis is prohibited;
means for receiving a requested biological sequence for which synthesis is desired; and
means for comparing the requested biological sequence to the database and comparing prohibiting synthesis of the requested biological sequence by the synthesizer if the requested biological sequence matches at least one prohibited biological sequence in the database, and allowing synthesis of the requested biological sequence by the synthesizer if no match is found in the database.

2. The system of claim 1, wherein the computer system is integrated into and positioned within the synthesizer.

3. The system of claim 2, wherein said means for receiving the requested biological sequence comprises a control panel of the synthesizer, said control panel allowing a user to input the requested biological sequence.

4. The system of claim 1, wherein the database is stored in the computer system.

5. The system of claim 1, wherein the database is external to the computer system.

6. The system of claim 1, wherein the synthesizer is disabled if the database is not updated within a pre-defined time period.

7. The system of claim 1, further comprising means for monitoring a plurality of requested sequences over time and determining whether the plurality of requested sequences, if synthesized and assembled, represent a biological hazard.

8. A system for prohibiting synthesis of dangerous biological sequences, comprising:
a synthesizer;
a remote central security server in communication with the synthesizer;
a computer system in communication with the remote central security synthesizer;
means in the remote central security server for receiving a requested biological sequence transmitted to the central security server by a user of the computer system;
a database including at least one prohibited biological sequence for which synthesis is prohibited;
means for comparing the requested biological sequence to the database and prohibiting synthesis of the requested biological sequence by the remote synthesizer if the requested biological sequence matches at least one prohibited biological sequence in the database, and allowing synthesis of the requested biological sequence by the remote synthesizer if no match is found in the database; and
means for transmitting the requested biological sequence to the remote synthesizer for subsequent synthesis of the requested biological sequence by the synthesizer if no match is found in the database.

9. The system of claim 8, further comprising means for verifying the identity of the user.

10. The system of claim 8, further comprising means for encrypting the requested biological sequence prior to transmission of the requested biological sequence to the remote central security server.

11. The system of claim 8, wherein the remote central security server communicates with a central database of prohibited biological sequences external to the central security server.

12. The system of claim 8, wherein the remote central security server communicates with a governmental agency if the requested biological sequence matches one or more prohibited biological sequences.

13. The system of claim 8, wherein the remote central security server registers each synthesize with which the server operates.

14. The system of claim 8, further comprising means for monitoring a plurality of requested sequences over time and determining whether the plurality of requested sequences, if synthesized and assembled, represent a biological hazard.

15. A chip for prohibiting synthesis of dangerous biological sequences by a synthesizer, comprising:
a non-volatile memory storing at least one biological sequence for which synthesis is prohibited; and
means for communicating with a controller of the synthesizer,
wherein the controller obtains the at least one biological sequence from the non-volatile memory and compares the at least one biological sequence with a requested biological sequence to determine whether to synthesize the requested biological sequence.

16. The chip of claim 15, wherein the synthesizer is inoperable without the chip installed in the synthesizer.

17. The chip of claim 1, further comprising means for monitoring a plurality of requested sequences over time and determining whether the plurality of requested sequences, if synthesized and assembled, represent a biological hazard.

18. A chip for prohibiting synthesis of dangerous biological sequences by a synthesizer, comprising:
an on-chip database storing at least one biological sequence for which synthesis is prohibited;
a processor in communication with the on-chip database;
means for receiving a requested biological sequence for which synthesis is desired; and
means for comparing the requested biological sequence to the on-chip database, the processor instructing the synthesizer to prohibit synthesis of the requested biological sequence if the requested biological sequence matches at least one biological sequence in the on-chip database for which synthesis is prohibited.

19. The chip of claim 18, wherein synthesizer is inoperable without the chip installed in the synthesizer.

20. The chip of claim 18, further comprising means for monitoring a plurality of requested sequences over time and determining whether the plurality of requested sequences, if synthesized and assembled, represent a biological hazard.

21. A method for prohibiting synthesis of dangerous biological sequences, comprising the steps of:
receiving at a computer system a requested biological sequence for which synthesis is desired;
comparing the requested biological sequence to a database containing at least one biological sequence for which synthesis is prohibited;
determining whether the requested biological sequence matches at least one biological sequence in the database;
if the requested biological sequence does not match at least one biological sequence in the database, electronically instructing a synthesizer in communication with the computer system to synthesize the requested biological sequence; and
if the requested biological sequence matches at least one biological sequence in the database, electronically locking a synthesizer in communication with the computer system to prohibit synthesis of the requested biological sequence.

22. The method of claim 21, further comprising communicating an alert to a governmental agency if the requested biological sequence matches at least one biological sequence in the database.

23. The method of claim 21, further comprising monitoring a plurality of requested sequences over time and determining whether the plurality of requested sequences, if synthesized and assembled, represent a biological hazard.

24. A computer-readable storage medium having computer-readable instructions stored thereon which, when executed by a computer system, cause the computer system to prohibit synthesis of dangerous biological sequences by a synthesizer in communication with the computer system, the instructions comprising the steps of:
receiving at a computer system a requested biological sequence for which synthesis is desired;
comparing the requested biological sequence to a database containing at least one biological sequence for which synthesis is prohibited;
determining whether the requested biological sequence matches at least one biological sequence in the database;
if the requested biological sequence does not match at least one biological sequence in the database, electronically instructing a synthesizer in communication with the computer system to synthesize the requested biological sequence; and
if the requested biological sequence matches at least one biological sequence in the database, electronically locking a synthesizer in communication with the computer system to prohibit synthesis of the requested biological sequence.

25. The computer-readable storage medium of claim 24, further comprising communicating an alert to a governmental agency if the requested biological sequence matches at least one biological sequence in the database.

26. The method of claim 24, further comprising monitoring a plurality of requested sequences over time and determining whether the plurality of requested sequences, if synthesized and assembled, represent a biological hazard.
